(19) United States
(12) Patent Application Publication
(10) Pub. No.: US 2006/0045310 A1
(43) Pub. Date: Mar. 2, 2006

(54) System and method for tracking articulated body motion

(75) Inventors: Peter Henry Tu, Niskayuna, NY (US); Timothy Patrick Kelliher, Scotia, NY (US); Jens Rittscher, Schenectady, NY (US); Nils Oliver Krahnstoever, Schenectady, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 10/927,206

(22) Filed: Aug. 27, 2004

(51) Int. Cl. G06K 9/00

(52) U.S. Cl. 382/103

(57) ABSTRACT

A system and method for tracking the movements of persons. The system includes at least two video devices and a computing device. The computing device is coupled to the at least two video devices and it includes a computing section capable of performing calculations to support mode stratified particle filtering. The method includes visually capturing a scene encompassing one or more strata, re-sampling each of the stratum, and redefining each of the stratum. The method further includes adding new or subtracting old strata based upon the arrival or departure of isolated targets within the scene and normalizing each of the stratum.

### BACKGROUND

The invention relates generally to a system and method for tracking articulated body motion, and more particularly to a system and method for estimating the articulated motion of the head and hands of one or multiple people.

The deployment of video surveillance systems, especially in retail environments, is known. Digital video is necessary to efficiently provide continuous surveillance. Conventional video surveillance systems utilize single methods, such as Multiple Hypothesis Tracking or Joint Probabilistic Data Association Filter, to track multiple objects. A disadvantage with such methods is that prior model assumptions and computational efficiency of such methods are not particularly robust. Another disadvantage is that the entrance and departure of new objects in a scene must be captured by the birth and death of new modes.

### BRIEF DESCRIPTION OF THE DRAWINGS

FIG. 1 schematically illustrates a tracking system in accordance with an exemplary embodiment of the invention.

FIG. 2 illustrates a method for mode stratified particle filtering in accordance with an exemplary embodiment of the invention.

FIG. 3 illustrates an application for the tracking system of FIG. 1.

FIG. 4 illustrates an RFID tag on an article for use with the tracking system of FIG. 1.

### SUMMARY

One exemplary embodiment of the invention is a system for tracking the movements of persons. The system includes a video capturing device capable of providing stereo views and a computing device coupled to the video capturing device. The computing device includes a computing section capable of performing calculations to support stochastic filtering.

One aspect of the exemplary system embodiment is system for tracking the behavior of a customer in a retail environment. The system includes at least two pan tilt zoom cameras and a computing device capable of performing calculations to support mode stratified particle filtering.

Another exemplary embodiment of the invention is a method for monitoring the movements of one or more persons. The method includes first visually capturing a scene encompassing one or more strata, second re-sampling each of the stratum, third redefining each of the stratum, and fourth adding new or subtracting old strata based upon the arrival or departure of isolated targets within the scene. The method also includes fifth normalizing each of the stratum and re-performing the second through fifth steps.

One aspect of the exemplary method embodiment is that the step of visually capturing a scene is accomplished with at least two video devices, and the step of re-sampling each of the stratum includes collecting hypotheses on how the one or more persons in the scene will move.

These and other advantages and features will be more readily understood from the following detailed description of preferred embodiments of the invention that is provided in connection with the accompanying drawings.

### DETAILED DESCRIPTION OF EXEMPLARY EMBODIMENTS

Embodiments of the invention, described herein, utilize entropy measures to control the process of sampling particles. The entropy measures are implemented through mode stratification.

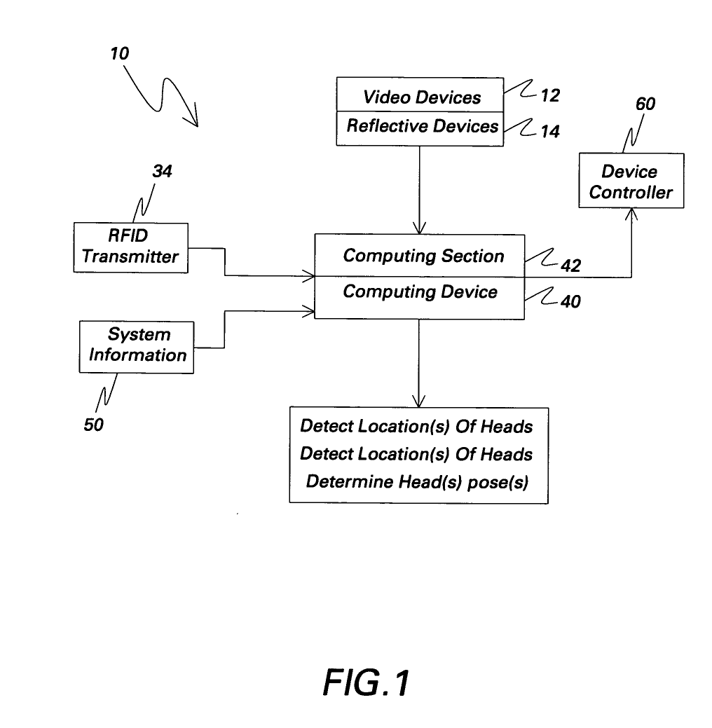

FIG. 1 illustrates a tracking system 10 that includes devices for capturing images and a device for interpreting the captured images. Specifically, one or more video devices 12 are included in the system 10. The video devices 12 are configured to provide stereo views. Stereo views may be obtained through the use of two or more video devices 12 being used in concert. Alternatively, stereo views may be obtained through positioning of reflective devices 14, such as mirrors, near a single video device 12 so as to provide more than one view. The device for interpreting the captured images is a computing device 40 that includes a computing section 42. The computing device 40 may be a personal computer or any other device suitable for performing calculations.

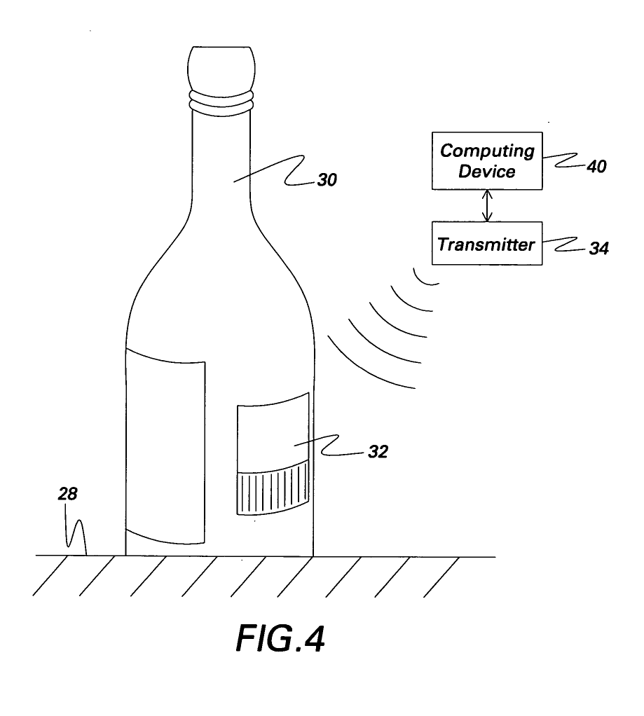

A radio frequency identification (RFID) transmitter 34 may optionally be included within the system 10. The transmitter 34 is configured to enable the computing device 40 to obtain information regarding the position of any item upon which an RFID tag 32 (FIG. 4) is located. Further, the computing device 40 is enabled to receive system information 50, which may be any pertinent information of the system or environment that the tracking system 10 is monitoring.

Finally, the system 10 may include a device controller 60 in communication with the computing device 40. The device controller 60 may control a device in the environment that the tracking system 10 is monitoring, and the device controller 60 may be controlled by the computing device 40. For example, the tracking system 10 may be utilized in an image guided manufacturing environment. In such an environment, computer-numerical-control (CNC) cutting machines may be incorporated. As a safety measure, the CNC cutting machines may be controlled by the device controller 60. Based upon images obtained through the video devices 12, the computing device 40 may determine that a health hazard has arisen (such as, for example, a person's hand has gotten too close to a cutting blade of one of the CNC cutting machines). In such an occurrence, the computing device 40 sends a signal to the device controller 60 to turn off the CNC cutting machine at issue.

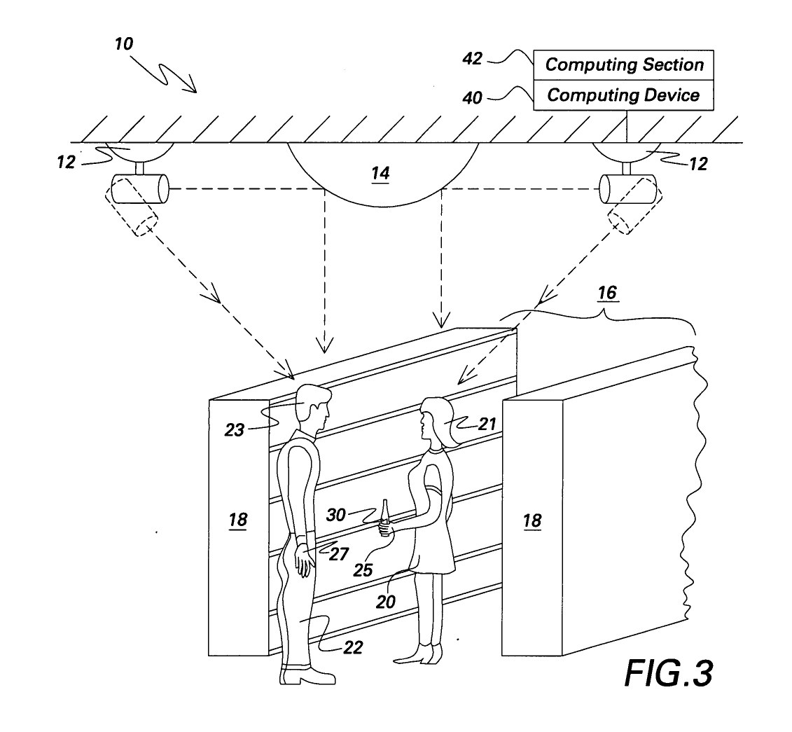

As another example, the tracking system 10 may be incorporated in a retail environment. This example will be further described with specific reference to FIG. 3. Another example of an application for the tracking system 10 is in a surgical navigation environment. For example, each of the surgical instruments may include an RFID tag 32. The video devices 12 capture images indicating the various positions of the heads and hands of surgical team members. By combining information from both the video devices 12 and the RFID tags 32, the computing device 40 can deduce, for example, whether the surgical team has left the operating room prior to removing all the surgical instruments.

Next will be described examples of algorithms that may be used in the computing device 40 to deduce head and hand position. The types of algorithms useful in deducing head and hand position may be collectively considered as stochastic filters. One example of a stochastic filter is a condensation filter. Another example of a stochastic filter is a mode stratified particle filter.

Stochastic filters, and in particular the mode stratified particle filter, utilize a Bayesian framework. In Bayesian sequential estimation, three main problems need to be addressed. Multi-modality must be maintained, and maintaining multiple modes of distribution with only a finite number of particles is a challenge. The performance of particle filters depends on prior model assumptions, and control mechanisms must be introduced that will improve the efficiency and robustness of the particle filters. In a dynamic environment, objects will enter and leave a particular scene, and a process modeling that environment must appropriately account for the entrance and exit of objects.

In a full Bayesian approach, the model selection would be based on evidence, which would be computationally infeasible. However, by learning the response of the likelihood function to the background, in the absence of any foreground object, it is possible to measure the distribution model for the posterior. Posterior distribution refers to the probability distribution of a state given all prior information and the current set of observations. Where the scene does not contain any foreground objects, the posterior should be similar to the learned background distribution. The similarity can be measured through relative entropy or Kullbach-Leibler divergence. Each of the disconnected areas of the scene that contain foreground objects has its own particle set to model the local distribution. Re-sampling of each particle set is done locally, due to the fact the dynamics and appearance of different foreground objects is statistically independent. The local re-sampling may be accomplished through, for example, mode stratification. In mode stratification, a stratum is defined to be the set of particles that represents a particular mode of the posterior distribution. The relative entropy of the distribution of each stratum should be significantly different from the learned background distribution. The cumulative measure of the relative entropies characterizes the fit of the observed data to the model. An empirical quantity, called the order parameter, is used to measure this fit. The order parameter is defined as:

$${Ω}_{t} = 1 \text{/} ( K + 1 ) ( KL ( {p}_{t}^{0} , {q}_{t} ) + {\sum }_{k = 1}^{K} 1 \text{/} ( KL ( {p}_{t}^{k} , {q}_{t} ) )$$

where qₜ is the learned background response and pₜ^{k} is a distribution associated with the k-th mode at time t. K is the total number of modes in the model, and KL is the Kullbach-Liebler divergence. The first term of the order parameter is the relative entropy between the posterior on the non-foreground region and a known background distribution qₜ. This first term provides a basis to ascertain if a new mode has been formed, due to the appearance of a new object, or if a mode of the distribution no longer corresponds to an object in the scene. A spike of the order parameter indicates a poor fit with the model, and generally corresponds with an event in the scene, i.e., an arrival or departure of an object. A poor fit leads to the need to adjust K, the total number of modes of the model to the posterior distribution.

The principle behind the algorithm used in mode stratification is to maximize the amount of information contained in the foreground while minimizing the amount of information in the background. By doing so, the existence of a true background distribution having a high relative entropy with respect to the distribution of the scene with our hypothesized foreground objects removed means that there is probably a new foreground object. The principle behind the algorithm is implement using a discretized control space X obtained as an image Ξ(X) of configuration space X under the mapping Ξ: X→X. The control space is utilized (1) to implement a stratification of the configuration space X so that modes can be represented in a statistically independent way, (2) in a re-sampling scheme which adapts automatically to maintain the information contained in each stratum, and (3) control birth and death of modes.

Mode stratification is managed in the control space, wherein each strata are defined and managed. The control space X is divided into disjoint cells of a fixed volume such that:
X=U Xᵢⱼ with Xᵢⱼ∩Xₖₗ=0.
Based upon this control space partitioning, the k-th stratum at time t, Vₜ^{k}, is defined as the collection of cells
Vₜ^{k}:=U Xᵢⱼ(i,j) [symbol] Iₜ^{k}
where Iₜ^{k} is the index set associated with each stratum. The dimensionality of the control space can be equal to the configuration space X or be lower. For example, when tracking the location and orientation of faces in three dimensions, it is possible to use a subdivision along the spatial dimensions alone, rather than along the entire six dimension configuration space X.

The size and the elements of each Vₜ^{k} are adaptively determined in the re-sampling step. A stratum is represented by a particle set Sₜ^{k} of size nₜ^{k}:

$${S}_{t}^{k} = \{ ( {x}_{k , t}^{i} , {π}_{k , t}^{i} , {ω}_{k , t}^{i} ) {{\vert}_{i = 1}}^{{n}_{i}^{k}} {x}_{k , t}^{i} {V}_{t}^{k} , {π}_{k , t}^{i} , {ω}_{k , t}^{i} {R}^{+} \}$$

$$where$$

$${\sum }_{k = 1}^{{K}_{t}} {\sum }_{i = 1}^{{n}_{t}^{k}} {π}_{k , t}^{i} = 1 , {\sum }_{i = 1}^{{n}_{t}^{k}} {ω}_{k , t}^{i} = 1 , k = 1 , … , {K}_{t} .$$

The π's are the ensemble weights of each particle, while the ω's are the stratum (local) weights of each particle. The posterior distribution is represented by the union of these particle sets, S=Sₜ^{k} and is approximated by

$$p ( {x}_{t} \vert {z}_{I : t} ) \approx {\sum }_{k = 1}^{{K}_{t}} {\sum }_{i = 1}^{{n}_{t}^{k}} {π}_{k , t}^{i} δ ( {x}_{t} - {x}_{k , t}^{i} ) .$$

The πⁱ_{k,t} encapsulate the relative heights of the peaks represented by each stratum, while the ωⁱ_{k,t} encapsulate the likelihood weights of the particles within each stratum. After each re-sampling, the state of each particle πⁱ_{k,t} changes, and so each individual particle set and its state variables and cell membership must be redefined accordingly. Such redefinition itself leads to potential splitting and merging of strata. Furthermore, the control space is used to maintain birth and death of strata that are responsible for managing the appearance and disappearance of tracks over time.

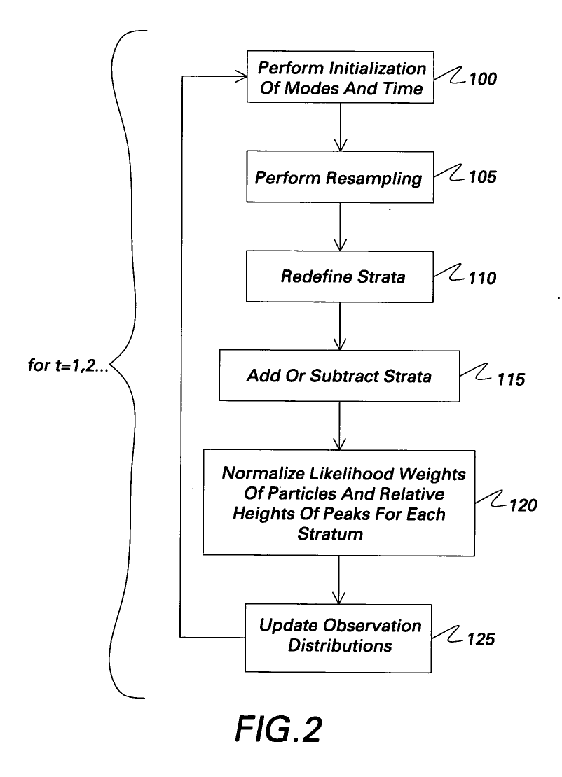

With specific reference to FIG. 2, next will be described a method for mode stratified particle filtering. At Step 100, an initialization of the modes and the time is performed. Specifically, t and K₀ are set at zero. The remaining steps are performed at time intervals. Specifically, at Step 105, a re-sampling of each stratum V_{k,t} is performed. For each stratum k, the posterior distribution (the sum of ωⁱ_{k,t}δ(xₜ-xⁱ_{k,t}) from i=1 to i=n^{k}ₜ) from the previous iteration is sampled to obtain a “local” posterior distribution (xⁱ_{k,t}, ωⁱ_{k,t}) for i=1 to i=n^{k}ₜ. The results are used to estimate πⁱ_{k,t} for i=1 to i=n^{k}ₜ, and hence the true posterior distribution of the current iteration. To obtain these posterior distributions with little computational effort, the choice of likelihood function becomes important. Once new particle positions are obtained from a Monte Carlo sampling of the old posterior, a proportion of the new particles are moved according to an autoregressive process motion model p(xₜ|xₜ₋₁). For each stratum, re-sampling continues until the measurement scores match the anticipated distribution, or the maximum number of particles is reached.

At Step 110, the strata are redefined. Specifically, after the re-sampling step, the preliminary strata particle sets are reorganized into Kₜ strata Vₜ^{k} based on the cells that are occupied under the mapping Ξ(x) for x [symbol] U Sₜ^{k}. Cells are organized into strata such that
Vₜ^{k}∩Vₜ^{k′}=0, for all k′≠k
and such that each stratum Vₜ^{k} includes one connected component with respect to the control space partition defined in
Vₜ^{k}:=U Xᵢⱼ(i,j) [symbol] Iₜ^{k}.
Based upon the preliminary sets Pₜ^{k} and the redefined strata, each strata's particles sets are constructed as
S′ₜ^{k}={(xⁱ_{m,t}, πⁱ_{m,t}, ωⁱ_{m,t}) [symbol] Sₜ^{m}: xⁱ_{m,t}Vₜ^{k}, m=1, . . . , Kₜ}.
Finally, the values of ωⁱ_{m,t} and πⁱ_{m,t} are renormalized and the parameters of the measurement scores Ĉ_{k,t}, Ŵ_{k,t} are updated for each new stratum.

Next, at Step 115, strata are created (birth) or deleted (death) based upon the arrival or departure of isolated targets. Cells of the control space are identified as belonging either to the background or the foreground. Each cell of the control space is associated with a likelihood value from strata samples occupying the strata cell or, if no particle resides in a cell, by sampling from the background configuration space. The control space is an image of the configuration space under the mapping Ξ(X). Each cell of the control space can be associated with a volume in configuration space as
Uᵢⱼ:={xX:Ξ(x)Xᵢⱼ}.
The control space distribution is defined as
P^{k}_{ij,t}=p(xUᵢⱼ|Zₜ^{k})=∫_{Uij}(p(Zₜ^{k}|x)p(x)/p(Zₜ^{k}))dx.
Z^{k} represents the observations Z with the target corresponding to the k-th stratum removed. The resulting control space distributions directly reflect the modal structure of the current configuration space and can be used to manage the death and birth of strata. If all visible targets are accounted for by existing strata and were to be removed from the configuration space, the remaining control space distribution should contain no further information. Alternatively, if visible targets remain, there is a higher information content and a resulting low entropy. Thus, the birth and death of strata can be managed by computing the relative entropy between the control space distributions p^{k}ₜ={p^{k}_{ij,t}} that is hypothesized to contain no targets for the birth process or only a single target for the death process, and a learned background reference distribution qₜ={q_{ij,t}}, which is known to contain no targets.

The creation of new stratum is triggered once the relative entropy between the control space distribution and the reference reaches a significant level. The deletion of an existing stratum is similarly decided by calculating the control space distribution for which all but the considered stratum are removed. When the relative entropy between this control space distribution and the background falls below a significant level, uniformity of the control space can be deduced and the strata is removed. The significance levels can be calculated based on the typical volume, W, of the strata in the control space. By assuming a uniform reference background volume, and the stratum in question is uniformly distributed over its control space,

$$KL ( W ) = {\sum }_{m} {p}_{t}^{m} log {p}_{t}^{m} \text{/} {q}_{t}^{m} = log N \text{/} ( W \text{/} V )$$

where N is the total number of cells in the control space and V is the volume of one control space cell. The stratum size is estimated based on the current noise variance of the target.

Next, at Step 120, the ωin each stratum is normalized and the πⁱ_{k,t} is normalized over all the strata. Finally, at Step 125, the parameters of the measurement scores C_{k,t}, W_{k,t} for each Z_{k,t} are updated for each new stratum.

With reference to FIG. 3, next will be described an application of the mode stratified particle filtering in a retail shopping context. As illustrated, a tracking system 10 includes a video apparatus that enables stereo views and that is connected with a computing device 40. The video apparatus may be two or more video devices 12, or it may be a single video device 12 used with a reflective device 14 to produce stereo views. The computing device 40 includes a computing section 42 capable of performing the mode stratified particle filtering process described herein.

Having at least two video devices 12 allows for a three-dimensional analysis of a scene by the use of triangulation and by adding at least a second perspective of the scene. The video devices 12 may be digital video cameras or analog video cameras in conjunction with an analog-to-digital converter (not shown). The video devices 12 may be pan-tilt-zoom cameras. Such pan-tilt-zoom cameras provide capability to rotate the video device 12 view so as to allow the video device 12 to capture a scene at a particular location. As shown in FIG. 3, a woman 20, holding a product 30, and a man 22 are positioned between a pair of shelves 18 within a scene 16 captured by a pair of video devices 12.

At Step 100 (FIG. 2), an initialization of modes and time is performed. Essentially, the video devices 12 capture the scene 16 and upload the data to the computing device 40 at time t=0. At time t=1, a re-sampling is performed at Step 105. The re-sampling is a collection of all the hypotheses on how the actors in a scene, in this case the woman 20 and the man 22 in the scene 16, will move. The re-sampling may include the movement of heads 21, 23, and it may include the movement of hands 25, 27. After re-sampling, the positions of the actors 20, 22, or parts thereof, such as, for example, their heads 21, 23 and/or their hands 25, 27 are redefined at Step 110. Then, based upon the re-sampling, actors in the scene 16 are added to or subtracted from the scene 16.

All of the hypotheses of how the actors in a scene will move that are derived through re-sampling are each assigned a numerical value attributable to the weight or likelihood that that hypothesis is a true representation of how the actors 20, 22 actually moved in the scene 16. At Step 120, the numerical values of the likelihood weights are normalized to add up to 1.0. Finally, at Step 125, observation distributions are updated. It is possible that an actor or an actor's hand or head may be obstructed from view of the video devices 12, and therefore subtracted from the scene 16 erroneously. When that occurs, and there is an inconsistency between what is known (for example, there are two actors 20, 22 in the scene 16) and what is hypothesized (there is only one actor in the scene 16), further sampling or other analysis is performed in Step 125 to quell the inconsistency. Steps 105 through 125 are repeated for time t=2, 3, 4, . . . n.

The process as described and shown in FIG. 2 may be used to ascertain the head location of one or more persons: By head location is meant not only the physical position of the head in a three-dimensional space, but also the direction that the face is projected, and whether the head is moving or stationary. For example, a head location that includes a head turning from side to side may indicate a person seeking out security personnel (a shoplifter wanting to avoid detection), or assistance (a shopper wanting a question answered).

The tracking system 10 may optionally include one or more devices 14 capable of reflecting an image. An example of such a device 14 is a mirrored dome. The mirrored domes 14 may be positioned at various strategic locations within an environment. For example, mirrored domes 14 may be located at various locations that are outside of the sight line of cashiers or other personnel. With the positioning of the mirrored domes 14, the video devices 12 are trained on the mirrored domes 14, instead of the actors, to capture a scene. Through the use of the mirrored domes 14, less video devices 12 may be necessary.

There are certain applications where the tracking of customers in a retail environment is important for both behavioral analysis and surveillance. Single modality tracking is, however, challenging due to clutter and occlusion and ambiguities with respect to the vast range of products with which a customer can interact. Next, with reference to FIGS. 3-4, will be described a multimodal tracking methodology that combines tracking a person's head and hands with the use of RFID tags. A product 30 is shown in FIG. 4 positioned on a shelf 28. The product 30 shown in FIG. 3 may be the same product 30 in the hand 25 of the woman 20 in FIG. 3. The product 30 includes a radio frequency identification (RFED) tag 32. The RFID tag 32 is scanned by a transmitter or antenna 34, which is in connection with the computing device 40.

As described above, the stereo video devices 12 are used to capture the scene 16 including the customers 20, 22. The video devices 12 observe the customers 20, 22, and body part locations are tracked in three dimensions and real-time using both anatomical constraints and the mode stratified particle filtering method (FIG. 2). The state of the product 30 is sensed through the use of the RFID tag 32. For example, based upon the signal strength determined from the scan of the RFID tag 32 by the transmitter 34 the orientation and/or the location of the product 30 can be determined. It should be appreciated that while only one transmitter 34 is shown, more than one transmitter 34 may be used. For example, with three transmitters 34, a complete position of the product 30 can be obtained, including the orientation of the product.

Combining the information on the customers gleaned through the use of the mode stratified particle filtering method and the information obtained through the transmitter 34 and the RFID tag 32, the state of the customer's interaction with the product 30 can be equated. Behavior analysis of customers, or surveillance, may be performed with the system 10. For example, the obtained information can be used to determine if the customer 20, 22 is tampering with the product 30, or whether the customer 20, 22 is interested in, stealing, or vandalizing the product 30.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed as new and desired to be protected by Letters Patent of the United States is:

1. A system for tracking the movements of persons, comprising:
a video capturing device capable of providing stereo views; and
a computing device coupled to said video capturing device, said computing device comprising a computing section capable of performing calculations to support stochastic filtering.

2. The system of claim 1, wherein said computing section is capable of performing calculation to support mode stratified particle filtering.

3. The system of claim 1, wherein the video capturing device comprises at least one digital video camera.

4. The system of claim 1, wherein the video capturing device comprises at least two video cameras.

5. The system of claim 4, wherein the at least two video cameras comprise analog video cameras and analog-to-digital converters.

6. The system of claim 4, wherein the at least two video cameras comprise pan tilt zoom cameras.

7. The system of claim 1, further comprising at least one reflective device for reflecting an image toward said video capturing device.

8. The system of claim 7, wherein said at least one reflective device comprises a mirrored dome.

9. The system of claim 1, further comprising at least one transmitter for scanning RFID tags on products.

10. The system of claim 9, wherein said computing section and said at least one transmitter are used to analyze the behavior of a person with regard to a product.

11. The system of claim 9 for use in a surgical navigation environment.

12. The system of claim 1 for use in a retail environment.

13. A system for tracking the behavior of a customer in a retail environment, comprising:
at least two video devices, wherein the at least two video devices comprise pan tilt zoom cameras; and
a computing device coupled to said at least two video devices, said computing device comprising a computing section capable of performing calculations to support mode stratified particle filtering.

14. The system of claim 13, wherein the at least two video devices comprise digital video cameras.

15. The system of claim 13, wherein the at least two video devices comprise analog video cameras and analog-to-digital converters.

16. The system of claim 13, further comprising at least one transmitter for scanning RFID tags on products.

17. The system of claim 16, wherein said computing section and said at least one transmitter are used to analyze the behavior of a person with regard to a product.

18. A method for monitoring the movements of one or more persons, comprising:
(a) visually capturing a scene encompassing one or more strata;
(b) re-sampling each said stratum;
(c) redefining each said stratum;
(d) adding new or subtracting old strata based upon the arrival or departure of isolated targets within the scene;
(e) normalizing each said stratum; and
(f) re-performing steps (b) through (e).

19. The method of claim 18, wherein said visually capturing a scene is accomplished with at least one video device.

20. The method of claim 19, wherein said at least one video device comprises a digital video camera.

21. The method of claim 19, wherein the at least one video device comprises at least two analog video cameras and analog-to-digital converters.

22. The method of claim 18, wherein said visually capturing a scene comprises initializing a mode for each said stratum.

23. The method of claim 18, wherein said re-sampling comprises collecting hypotheses on how the one or more persons in the scene will move.

24. The method of claim 23, wherein said re-sampling comprises collecting hypotheses on the movement of heads.

25. The method of claim 23, wherein said re-sampling comprises collecting hypotheses on the movement of hands.

26. The method of claim 18, wherein said redefining comprises re-determining the positions of the one or more persons in the scene.

27. The method of claim 26, wherein said re-determining comprises re-determining the position of the heads of the one or more persons.

28. The method of claim 26, wherein said re-determining comprises re-determining the position of the hands of the one or more persons.

29. A method for monitoring the movements of one or more persons, comprising:
(a) visually capturing a scene encompassing one or more strata, wherein said visually capturing a scene is accomplished with at least two video devices;
(b) re-sampling each said stratum, wherein said re-sampling comprises collecting hypotheses on how the one or more persons in the scene will move;
(c) redefining each said stratum;
(d) adding new or subtracting old strata based upon the arrival or departure of isolated targets within the scene;
(e) normalizing each said stratum; and
(f) re-performing steps (b) through (e).

30. The method of claim 29, wherein said at least two video devices comprise digital video cameras.

31. The method of claim 29, wherein the at least two video devices comprise analog video cameras and analog-to-digital converters.

32. The method of claim 29, wherein said visually capturing a scene comprises initializing a mode for each said stratum.

33. The method of claim 29, wherein said re-sampling comprises collecting hypotheses on the movement of heads.

34. The method of claim 29, wherein said re-sampling comprises collecting hypotheses on the movement of hands.

35. The method of claim 29, wherein said redefining comprises re-determining the positions of the one or more persons in the scene.

36. The method of claim 35, wherein said re-determining comprises re-determining the position of the heads of the one or more persons.

37. The method of claim 35, wherein said re-determining comprises re-determining the position of the hands of the one or more persons.
